(19) United States
(12) Patent Application Publication
(10) Pub. No.: US 2026/0067804 A1
(43) Pub. Date: Mar. 5, 2026

(54) PEER-TO-PEER TWT OPERATION

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US); Yue Qi, Plano, TX (US); Bilal Sadiq, Plano, TX (US)

(21) Appl. No.: 19/309,416

(22) Filed: Aug. 25, 2025

Related U.S. Application Data
(60) Provisional application No. 63/688,159, filed on Aug. 28, 2024.
(60) Provisional application No. 63/689,492, filed on Aug. 30, 2024.
(60) Provisional application No. 63/690,177, filed on Sep. 3, 2024.

(51) Int. Cl. H04W 52/02; H04L 67/104

(52) U.S. Cl. CPC H04W 52/0216; H04L 67/104

(57) ABSTRACT

A station (STA) includes a processor, and a transceiver operably coupled to the processor. The transceiver is configured to, as part of a peer-to-peer (P2P) target wake time (TWT) negotiation, transmit, to an access point (AP), a channel usage request frame including (i) an indication indicating a P2P TWT schedule unavailability mode and (ii) P2P TWT schedule information. The transceiver is also configured to, as part of the P2P TWT negotiation, receive, from the AP, in response to transmission of the channel usage request frame, a channel usage response frame.

### CROSS-REFERENCE TO RELATED APPLICATION(S) AND CLAIM OF PRIORITY

This application claims priority under 35 U.S.C. § 119(e) to U.S. Provisional Patent Application No. 63/688,159 filed on Aug. 28, 2024, U.S. Provisional Patent Application No. 63/689,492 filed on Aug. 30, 2024, and U.S. Provisional Patent Application No. 63/690,177 filed on Sep. 3, 2024. The above-identified provisional patent applications are hereby incorporated by reference in their entirety.

### TECHNICAL FIELD

This disclosure relates generally to wireless networks. More specifically, this disclosure relates to enhanced peer-to-peer (P2P) target wake time (TWT) operation.

### BACKGROUND

Wireless Local Area Network (WLAN) technology allows devices to access the internet in the 2.4 GHz, 5 GHZ, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for enhanced P2P TWT operation.

In one embodiment, a station (STA) is provided. The STA includes a processor, and a transceiver operably coupled to the processor. The transceiver is configured to, as part of a peer-to-peer (P2P) target wake time (TWT) negotiation, transmit, to an access point (AP), a channel usage request frame including (i) an indication indicating a P2P TWT schedule unavailability mode and (ii) P2P TWT schedule information. The transceiver is also configured to, as part of the P2P TWT negotiation, receive, from the AP, in response to transmission of the channel usage request frame, a channel usage response frame.

In another embodiment, an AP is provided. The AP includes a processor, and a transceiver operably coupled to the processor. The transceiver is configured to, as part of a P2P TWT negotiation, receive, from a STA, a channel usage request frame including (i) an indication indicating a P2P TWT schedule unavailability mode and (ii) P2P TWT schedule information. The transceiver is also configured to, as part of the P2P TWT negotiation, transmit, to the STA, in response to receipt of the channel usage request frame, a channel usage response frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The following documents and standards descriptions are hereby incorporated into the present disclosure as if fully set forth herein: [1] IEEE P802.11be—D6.0 “Part 11: Wireless LAN Medium Access Control (MAC) and Physical Layer (PHY) Specifications—Amendment 2: Enhancements for extremely high throughput (EHT)”; and [2] IEEE P802.11 REVme Draft D6.0 “Part 11: Wireless LAN Medium Access Control (MAC) and Physical Layer (PHY) Specifications”.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure

FIG. 3 illustrates an example wireless network where infrastructure traffic and non-infrastructure traffic coexist according to embodiments of the present disclosure;

FIG. 4 illustrates an example of an unavailability indication of a first STA to an AP due to a scheduled P2P communication with a second STA according to embodiments of the present disclosure;

FIG. 5 illustrates an example of an unavailability indication of a first STA to an AP due to a scheduled coex event with a second STA according to embodiments of the present disclosure;

FIG. 6 illustrates an example of an unavailability schedule or P2P TWT SPs according to embodiments of the present disclosure;

FIG. 7 illustrates an example of an unavailability schedule or P2P TWT SPs for a complete unavailability mode according to embodiments of the present disclosure;

FIG. 8 illustrates an example of an unavailability schedule or P2P TWT SPs for a probabilistic unavailability mode according to embodiments of the present disclosure;

FIG. 9 illustrates an example of an AP behavior for a complete unavailability mode according to embodiments of the present disclosure;

FIG. 10 illustrates an example of a AP behavior during a probabilistic unavailability mode according to embodiments of the present disclosure;

FIG. 11 illustrates another example of a AP behavior during a probabilistic unavailability mode according to embodiments of the present disclosure;

FIG. 12 illustrates another example of a AP behavior during a probabilistic unavailability mode according to embodiments of the present disclosure;

FIG. 13 illustrates another example of a AP behavior during a probabilistic unavailability mode according to embodiments of the present disclosure;

FIG. 14 illustrates an example format of a channel usage element including a usage mode field according to embodiments of the present disclosure;

FIG. 15 illustrates an example format of an unavailability probability field according to embodiments of the present disclosure;

FIG. 16 illustrates an example format of a channel usage response frame containing an unavailability probability field according to embodiments of the present disclosure;

FIG. 17 illustrates an example format of a QoS-aware unavailability indication option as a mode of P2P TWT unavailability according to embodiments of the present disclosure;

FIG. 18 illustrates an example format of a channel usage request frame including a QoS information element field according to embodiments of the present disclosure;

FIG. 19 illustrates example format of a QoS information element that includes a single TID value according to embodiments of the present disclosure;

FIG. 20 illustrates an example of STA availability for receiving a frame corresponding to a TID value in a QoS information element according to embodiments of the present disclosure;

FIG. 21 illustrates example format of a QoS information element that includes a multiple TID values according to embodiments of the present disclosure;

FIG. 22 illustrates another example format of a QoS information element that includes a multiple TID values according to embodiments of the present disclosure;

FIG. 23 illustrates an example format of a channel usage response frame including a QoS information element according to embodiments of the present disclosure;

FIG. 24 illustrates an example of STA availability for receiving a frame corresponding to a TID listed in a QoS information element according to embodiments of the present disclosure;

FIG. 25 illustrates another example of STA availability for receiving a frame corresponding to a TID listed in a QoS information element according to embodiments of the present disclosure; and

FIG. 26 illustrates an example method for enhanced P2P TWT operation according to embodiments of the present disclosure.

### DETAILED DESCRIPTION

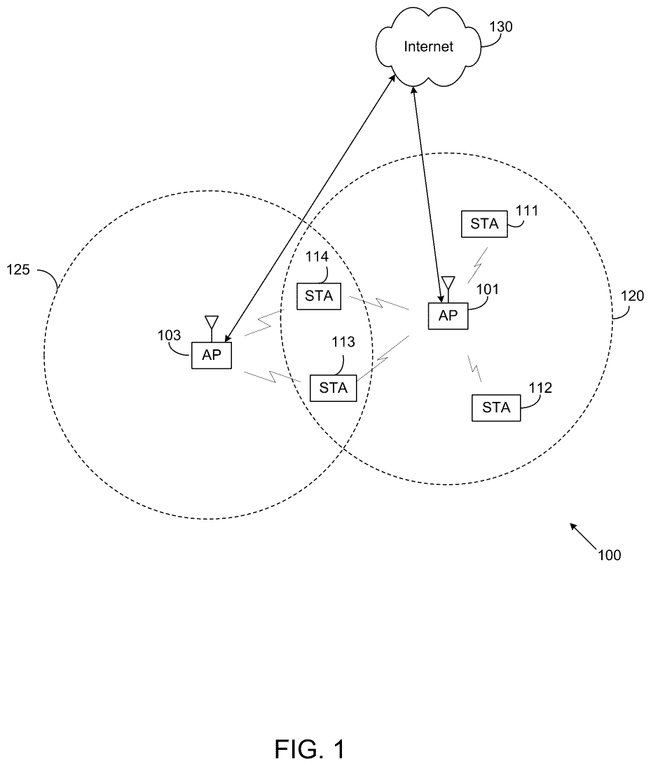

FIGS. 1 through 26, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

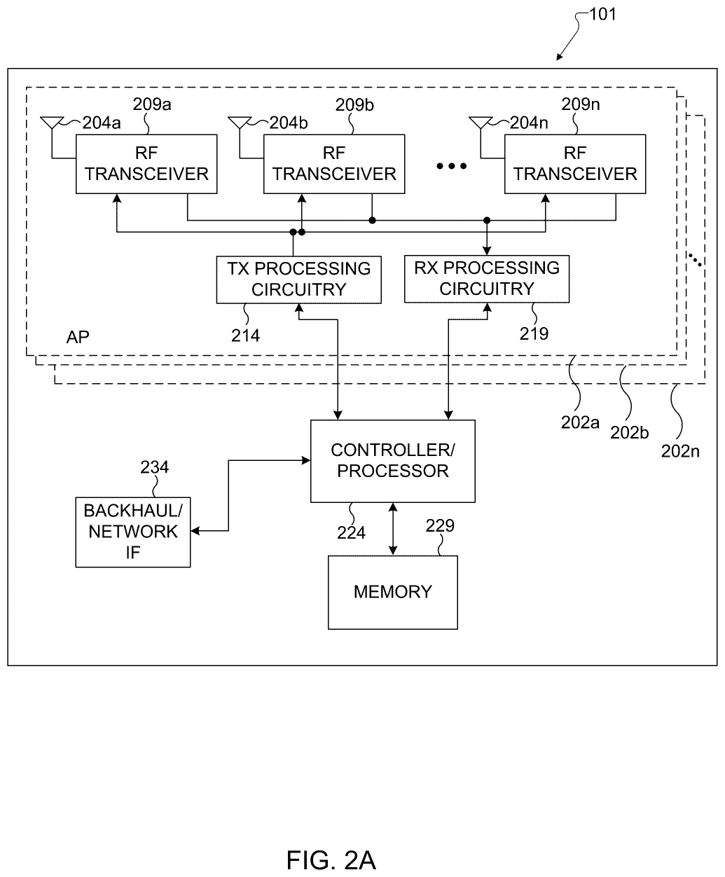

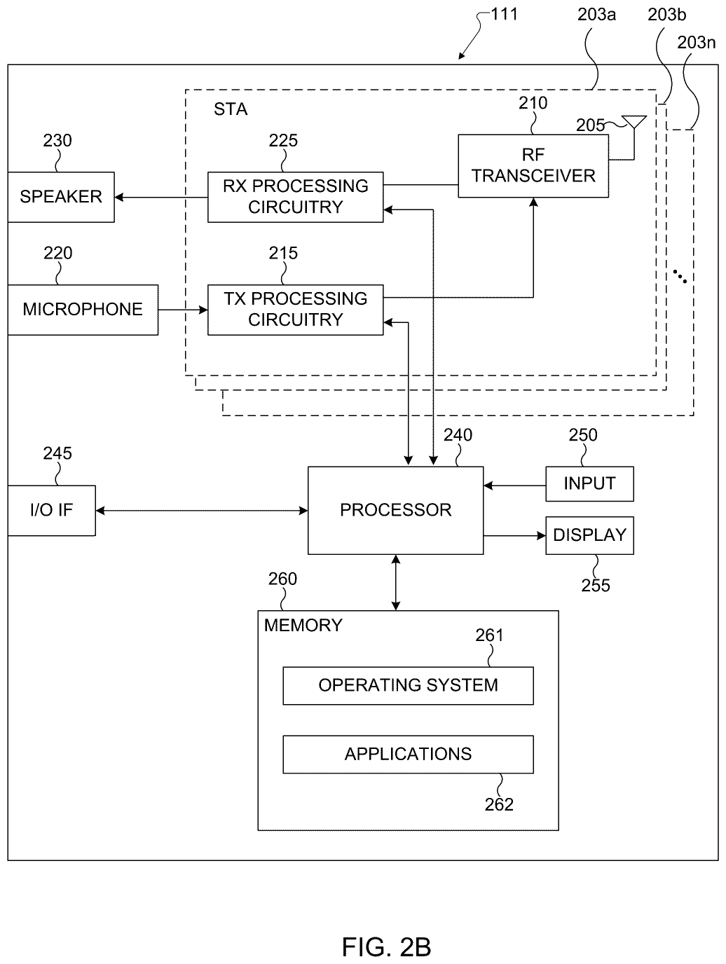

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHZ, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

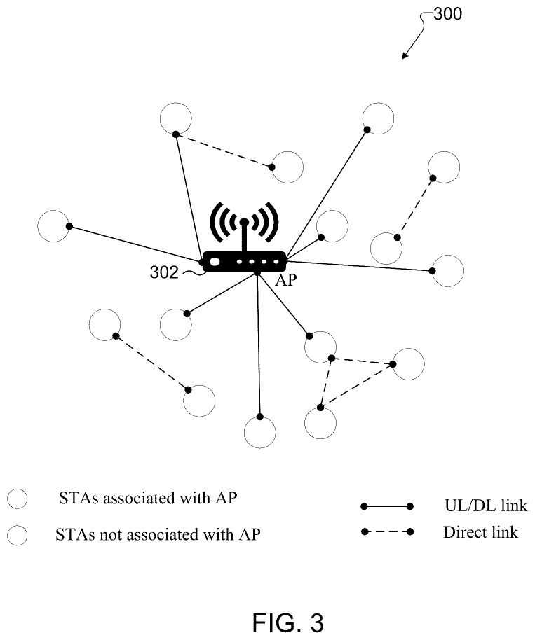

Better support for low-latency applications is desirable in next generation WLAN systems. It is not uncommon to observe numerous devices operating on the same wireless network. Many of such devices may be latency-tolerant but still contend with the devices with low-latency applications for the same time and frequency resources. In some cases, the AP as the network controller may not have enough control over the unregulated/unmanaged traffic that contends with the low-latency traffic within the infrastructure basic service set (BSS). Some of the unmanaged traffic that interferes with the AP's BSS's latency sensitive traffic may come from uplink (UL)/downlink (DL) or direct link communications within the infrastructure BSS that the AP manages. Other interference with the AP's BSS's latency sensitive traffic may be due to transmission in a neighboring infrastructure (overlapping) BSS (OBSS). Yet other interference with the AP's BSS's latency sensitive traffic may come from a neighboring independent BSS or P2P network as shown in FIG. 3.

FIG. 3 illustrates an example of wireless network 300 where infrastructure traffic and non-infrastructure traffic coexist according to embodiments of the present disclosure. The embodiment of a wireless network of FIG. 3 is for illustration only. Different embodiments of a wireless network where infrastructure traffic and non-infrastructure traffic coexist could be used without departing from the scope of this disclosure.

In the example of FIG. 3, an AP 302 is associated with several STAs. The traffic between the AP and associated STAs is infrastructure traffic with respect to the network of AP 302. FIG. 3 also shows several STAs not associated with AP 302. Traffic generated by or transmitted to the STAs not associated with AP 302 is non-infrastructure traffic with respect to the network of AP 302.

Although FIG. 3 illustrates an example wireless network 300 where infrastructure traffic and non-infrastructure traffic coexist, various changes may be made to FIG. 3. For example, FIG. 3 could include additional APS, fewer or more STAs, etc. according to particular needs.

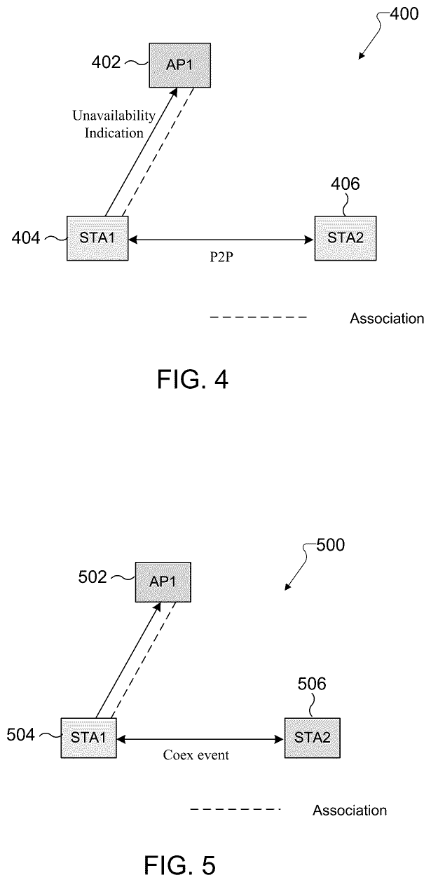

According to existing WLAN standards, a first STA can indicate to its associated AP a sequence of time periods during which the first STA will be unavailable for frame exchanges with the AP. During the unavailability with the AP, the first STA may be involved in P2P communication with a second STA as shown in FIG. 4. Alternatively, the first STA may also be unavailable due to a scheduled coexistence (coex) event, for example, with STA2 as shown in FIG. 5.

FIG. 4 illustrates an example 400 of an unavailability indication of a first STA to an AP due to a scheduled P2P communication with a second STA according to embodiments of the present disclosure. The embodiment of an unavailability indication of FIG. 4 is for illustration only. Different embodiments of an unavailability indication of a first STA to an AP due to a scheduled P2P communication with a second STA could be used without departing from the scope of this disclosure.

In the example of FIG. 4, AP 402 (AP1) is associated with STA 404 (STA1), and STA 404 is involved in a scheduled P2P communication with STA 406 (STA2). STA 404 is transmitting an unavailability indication to AP 402 because of the scheduled P2P communication with STA 406.

Although FIG. 4 illustrates an example 400 of an unavailability indication of a first STA to an AP due to a scheduled P2P communication with a second STA, various changes may be made to FIG. 4. For example, STA 404 could be involved with P2P communications with other STAs, etc. according to particular needs.

FIG. 5 illustrates an example 500 of an unavailability indication of a first STA to an AP due to a scheduled coex event with a second STA according to embodiments of the present disclosure. The embodiment of an unavailability indication of FIG. 5 is for illustration only. Different embodiments of an unavailability indication of a first STA to an AP due to a scheduled coex event with a second STA could be used without departing from the scope of this disclosure.

In the example of FIG. 5, AP 502 (AP1) is associated with STA 504 (STA1), and STA 504 is involved in a scheduled coex event with STA 506 (STA2). STA 504 is transmitting an unavailability indication to AP 502 because of the scheduled coex event with STA 506.

Although FIG. 5 illustrates an example 500 of an unavailability indication of a first STA to an AP due to a scheduled coex event with a second STA, various changes may be made to FIG. 5. For example, STA 504 could be involved with coex events with other STAs, etc. according to particular needs.

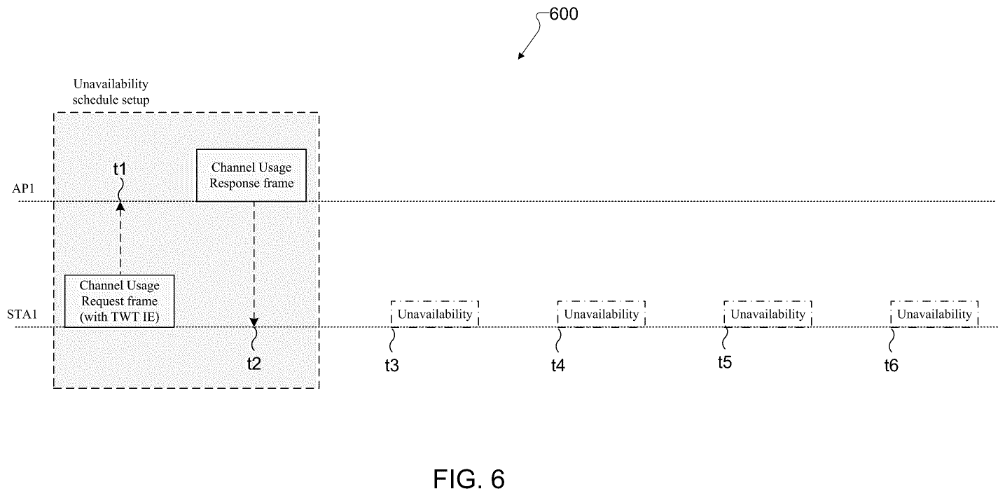

For the scenario where a first STA has set up an unavailability schedule or peer-to-peer (P2P) target wake time (TWT) schedule with its associated AP, existing baseline WLAN specifications do not provide a mechanism for the first STA to change the parameters of the unavailability service period (SP) or P2P TWT SPs as shown in FIG. 6.

FIG. 6 illustrates an example 600 of an unavailability schedule or P2P TWT SPs according to embodiments of the present disclosure. The embodiment of an unavailability schedule or P2P TWT SPs of FIG. 6 is for illustration only. Different embodiments of an unavailability schedule or P2P TWT SPs could be used without departing from the scope of this disclosure.

In the example of FIG. 6, AP1 and STA1 perform an unavailability schedule setup where at time “t1” STA1 transmits a channel usage request frame with a TWT information element (IE) to AP1, and STA1 receives a channel usage response frame from AP1 at time “t2” After the unavailability schedule setup, STA1 is unavailable to AP1 for a number of fixed time periods beginning at times “t3”, “t4”, “t5”, and “t6”. These periods may correspond with an unavailability schedule or P2P TWT SPs

Although FIG. 6 illustrates an example 600 of an unavailability schedule or P2P TWT SPs, various changes may be made to FIG. 6. For example, various changes to unavailability times could be made, etc. according to particular needs.

Once a first STA has established a P2P TWT schedule with its associated AP, it is possible that the first STA is still available during a first set of P2P TWT SPs, while not available during a second set of P2P TWT SPs, where both the first and the second sets of the P2P TWT SPs correspond to the same first P2P TWT schedule that the first STA has established with the AP. However, the first STA cannot predict ahead of time during which P2P TWT SPs the STA would still be available and during which P2P TWT SPs the STA would not be available.

In existing wireless networks, there is no mechanism that would enable the AP to communicate with the STA during a P2P TWT SP. Various embodiments or the present disclosure provide mechanisms and frameworks for a change of parameters for the unavailability schedule or P2P TWT schedule that has been set up with the AP. Various embodiments of the present disclosure also provide mechanisms and frameworks for receiving urgent traffic during a peer-to-P2P TWT SP.

In some embodiments, a STA that has established a P2P TWT schedule may still be available for frame exchange during some of the unavailability windows. There can be some uncertainty about the availability of the STA during the negotiated unavailability SPs. The STA can opportunistically retrieve DL frames from the AP during some of the SPs. For example, there can be a mechanism for the AP to check the availability of the STA during a P2P TWT SP that the STA has negotiated with that AP.

In some embodiments, for the scenario where a first STA has established a first P2P TWT schedule with a second STA to indicate a series of service periods during which the first STA are expected to be unavailable, the first STA can still be unavailable for communication with the second STA during a first set of P2P TWT SPs, and the first STA can be available for communication with the second STA during a second set of P2P TWT SPs, where both the first and the second sets of P2P TWT SPs correspond to the same first P2P TWT schedule.

For any of the embodiments described herein, the first STA can be an AP or a non-AP STA, and the second STA can be an AP or a non-AP STA.

In some embodiments, for the scenario where a first STA establishes a first P2P TWT schedule with an AP, the first STA can indicate different modes of the P2P TWT schedule that the first STA intends to establish with the AP. These modes may include the following:
Mode-1: Complete Unavailability
Mode-2: Probabilistic Unavailability

In existing wireless networks, there is no mechanism to indicate different modes of probabilistic unavailability of a P2P TWT. Various embodiments of the present disclosure provide mechanisms and frameworks for indicating different modes of P2P TWT operation.

In some embodiments, when a first STA intends to establish a P2P TWT schedule with its associated AP in order to indicate the unavailability schedule of the STA (for example, by including an individual TWT element), and sends a channel usage request frame to the AP in order to establish the peer-to-peer TWT schedule with the AP, the first STA may also indicate the modes of the negotiated P2P TWT schedule. For example, the first STA may indicate whether the P2P TWT is for a complete unavailability mode or for a probabilistic unavailability mode.

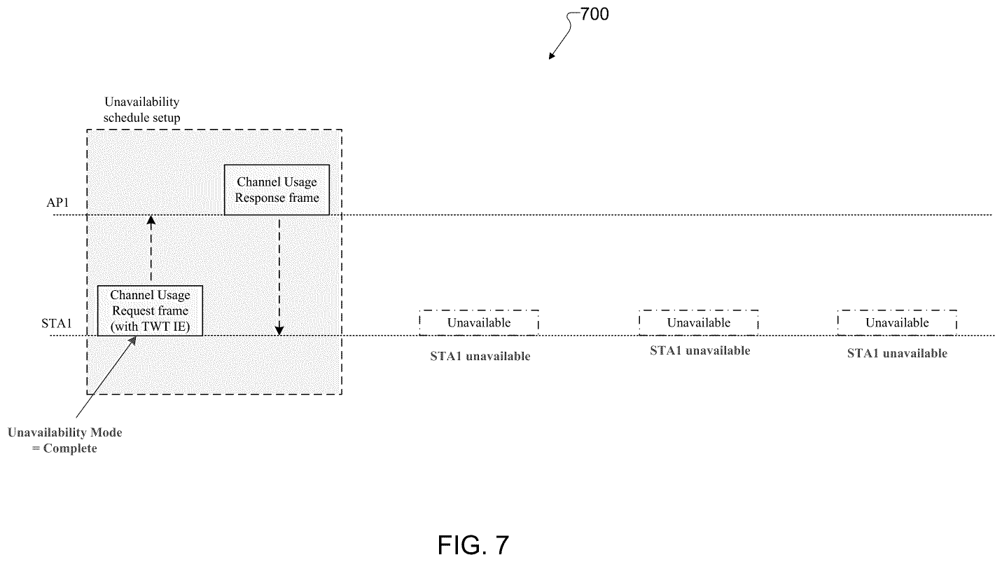

In some embodiments, for the scenario where a first STA establishes a first P2P TWT schedule with an associated AP, if the first STA, during the P2P TWT schedule negotiation phase, indicates that the mode of unavailability of the P2P TWT schedule is the complete unavailability mode (Mode-1), then after successfully setting up the P2P TWT schedule, the first STA may not be available for communication with the AP during any of the P2P TWT SPs corresponding to the P2P TWT schedule, as shown in FIG. 7

FIG. 7 illustrates an example 700 of an unavailability schedule or P2P TWT SPs for a complete unavailability mode according to embodiments of the present disclosure. The embodiment of an unavailability schedule or P2P TWT SPs of FIG. 7 is for illustration only. Different embodiments of an unavailability schedule or P2P TWT SPs could be used without departing from the scope of this disclosure.

In the example of FIG. 7, AP1 and STA1 perform an unavailability schedule setup where STA1 transmits a channel usage request frame with a TWT IE to AP1 that includes an indication for a complete unavailability mode, and STA1 receives a channel usage response frame from AP1. After the unavailability schedule setup, STA1 is unavailable to AP1 for a number of fixed time periods. These periods may correspond with an unavailability schedule or P2P TWT SPs.

Although FIG. 7 illustrates an example 700 of an unavailability schedule or P2P TWT SPs for a complete unavailability mode, various changes may be made to FIG. 7. For example, various changes to unavailability times could be made, etc. according to particular needs.

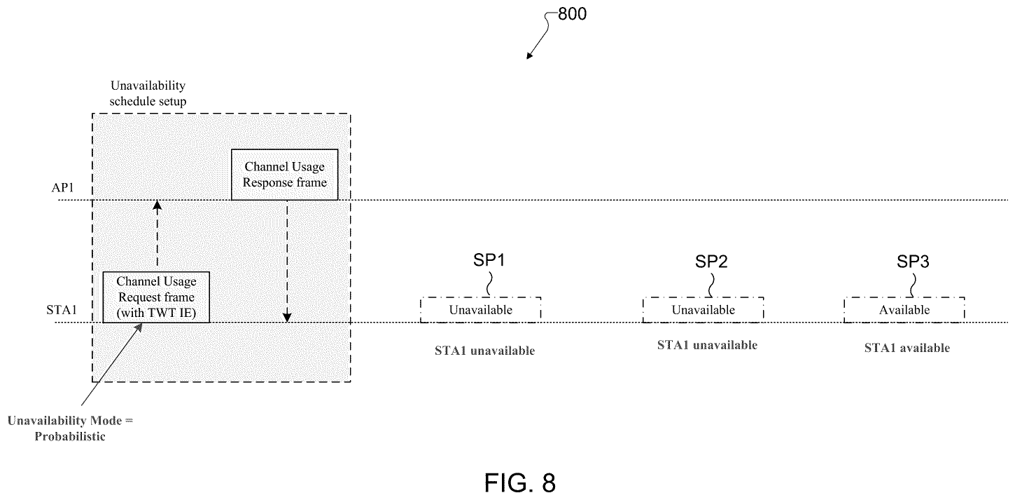

In some embodiments, for the scenario where a first STA establishes a first P2P TWT schedule with an associated AP, if the first STA, during the P2P TWT schedule negotiation phase, indicates that the mode of unavailability of the P2P TWT schedule is the probabilistic unavailability mode (Mode-2), then after successfully setting up the P2P TWT schedule, the first STA may be unavailable in a first subset of P2P TWT SPs, whereas the first STA may be available for communication with the AP during a second subset of P2P TWT SPs, where both the first and the second sets of P2P TWT SPs correspond to the same first P2P TWT schedule, as shown in FIG. 8.

FIG. 8 illustrates an example 800 of an unavailability schedule or P2P TWT SPs for a probabilistic unavailability mode according to embodiments of the present disclosure. The embodiment of an unavailability schedule or P2P TWT SPs of FIG. 8 is for illustration only. Different embodiments of an unavailability schedule or P2P TWT SPs could be used without departing from the scope of this disclosure.

In the example of FIG. 8, AP1 and STA1 perform an unavailability schedule setup where STA1 transmits a channel usage request frame with a TWT IE to AP1 that includes an indication for a probabilistic unavailability mode, and STA1 receives a channel usage response frame from AP1. After the unavailability schedule setup, STA1 is unavailable to AP1 for a number of fixed time periods (SP1, SP2), while STA1 is unavailable to AP1 for a number of fixed time periods (SP3). These periods may correspond with an unavailability schedule or P2P TWT SPs.

Although FIG. 8 illustrates an example 800 of an unavailability schedule or P2P TWT SPs for a probabilistic unavailability mode, various changes may be made to FIG. 8. For example, various changes to unavailability times could be made, etc. according to particular needs.

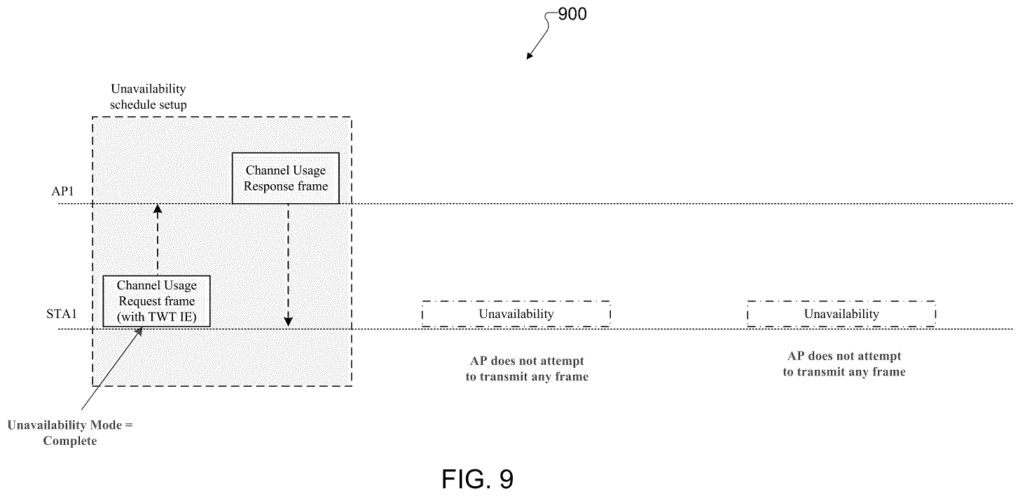

In some embodiments, for the scenario where a first STA establishes a first P2P TWT schedule with an associated AP, if the first STA, during the P2P TWT schedule negotiation phase, indicates that the mode of unavailability of the P2P TWT schedule is the complete unavailability mode (Mode-1), then during the P2P TWT SPs corresponding to the P2P TWT schedule the AP does not attempt to communicate with the first STA and assumes the first STA to be completely unavailable during the SPs. During the P2P TWT SPs, the AP may not attempt to deliver any downlink packets or BUs to the first STA, as shown in FIG. 9.

FIG. 9 illustrates an example 900 of an AP behavior for a complete unavailability mode according to embodiments of the present disclosure. The embodiment of AP behavior of FIG. 9 is for illustration only. Different embodiments of AP behavior for a complete unavailability mode could be used without departing from the scope of this disclosure.

In the example of FIG. 9, AP1 and STA1 perform an unavailability schedule setup where STA1 transmits a channel usage request frame with a TWT IE to AP1 that includes an indication for a complete unavailability mode, and STA1 receives a channel usage response frame from AP1. After the unavailability schedule setup, AP1 does not attempt to deliver any downlink packets or buffered units (BUs) to the first STA.

Although FIG. 9 illustrates an example 900 of an unavailability schedule or P2P TWT SPs for a complete unavailability mode, various changes may be made to FIG. 9. For example, various changes to unavailability times could be made, etc. according to particular needs.

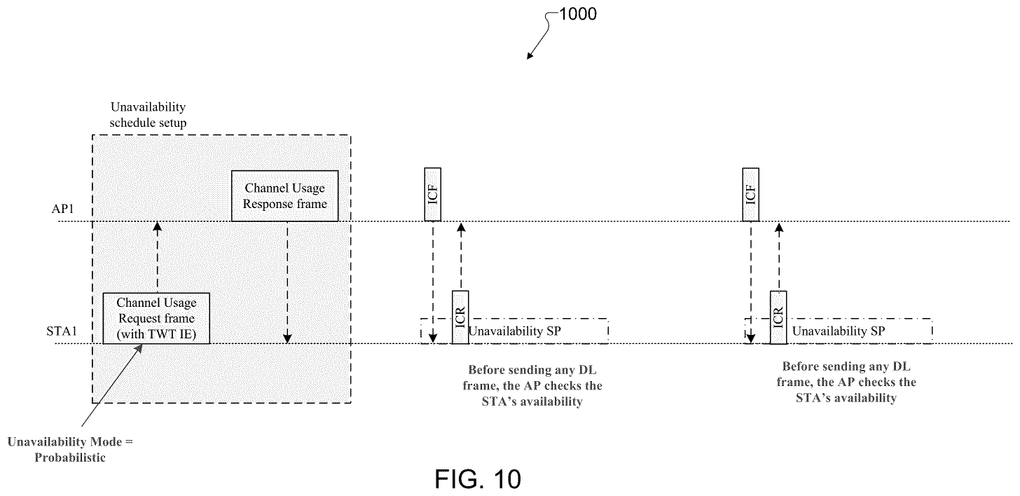

In some embodiments, for the scenario where a first STA establishes a first P2P TWT schedule with an associated AP, if the first STA, during the P2P TWT schedule negotiation phase, indicates that the mode of unavailability of the P2P TWT schedule is the probabilistic unavailability mode (Mode-2), then during the P2P TWT SPs corresponding to the P2P TWT schedule the AP may send an initial frame during the SP to check whether the first STA is available t for frame exchange during the P2P TWT SP. For instance, in some embodiments the AP can send an initial control frame (ICF) to the first STA at the beginning of the P2P TWT SP. If the AP receives a response from the first STA indicating that the first STA is available during the SP, then the AP can send downlink frames to the STA during the SP based on the availability indicated by the first STA in a response frame (ICR). In the ICR, if the first STA indicates that it is not available for the remainder of the SP, then the AP does not send any frame to the STA during the SP or does not solicit any uplink frame during the SP, as shown in FIG. 10.

FIG. 10 illustrates an example of AP behavior 1000 during a probabilistic unavailability mode according to embodiments of the present disclosure. The embodiment AP behavior of FIG. 10 is for illustration only. Different embodiments of AP behavior during a probabilistic unavailability mode could be used without departing from the scope of this disclosure.

In the example of FIG. 10, AP1 and STA1 perform an unavailability schedule setup where STA1 transmits a channel usage request frame with a TWT IE to AP1 that includes an indication for a probabilistic unavailability mode, and STA1 receives a channel usage response frame from AP1. After the unavailability schedule setup, AP1 sends an ICF to STA1 at the beginning of the P2P TWT SP, and receives an ICR. If the ICR indicates that STA1 is available during the SP, then AP1 can send downlink frames to the STA1 during the SP based on the availability indicated in the response frame. IF the ICR indicates that STA1 is not available during the SP, then AP1 does not send any frames to STA1 during the SP or does not solicit any uplink frames during the SP.

Although FIG. 10 illustrates an example of AP behavior 1000 during a probabilistic unavailability mode, various changes may be made to FIG. 10. For example, various changes to unavailability times could be made, etc. according to particular needs.

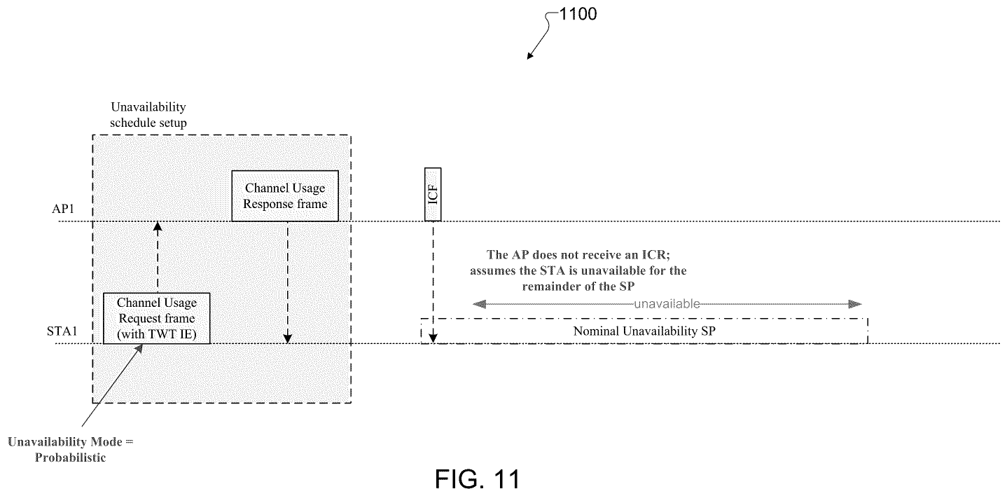

In some embodiments, for the scenario where a first STA establishes a first P2P TWT schedule with an associated AP, if the first STA, during the P2P TWT schedule negotiation phase, indicates that the mode of unavailability of the P2P TWT schedule is the probabilistic unavailability mode (Mode-2), and if the AP sends an ICF to check the first STA's availability during the SP, and does not receive any response frame back from the first STA, then the AP may not send any frame (e.g. DL BUs) to the STA during the SP or may not solicit any uplink frame during the remaining portion of the SP, as shown in FIG. 11. In some embodiments, even if the AP did not receive a response frame from the STA, the AP may not assume that the channel between the AP and the STA is bad and may not reduce the rate or reduce the MCS for the first STA, and the AP may not attempt to retransmit to the first STA any further DL frames during the same SP.

FIG. 11 illustrates another example 1100 of AP behavior during a probabilistic unavailability mode according to embodiments of the present disclosure. The embodiment of AP behavior of FIG. 11 is for illustration only. Different embodiments of AP behavior during a probabilistic unavailability mode could be used without departing from the scope of this disclosure.

In the example of FIG. 11, AP1 and STA1 perform an unavailability schedule setup where STA1 transmits a channel usage request frame with a TWT IE to AP1 that includes an indication for a probabilistic unavailability mode, and STA1 receives a channel usage response frame from AP1. After the unavailability schedule setup, AP1 sends an ICF to STA1 at the beginning of the P2P TWT SP. AP1 does not receive an ICR in response, and assumes that STA1 is unavailable for the remainder of the SP.

Although FIG. 11 illustrates an example 1100 of AP behavior during a probabilistic unavailability mode, various changes may be made to FIG. 11. For example, various changes to unavailability times could be made, etc. according to particular needs.

In some embodiments, for the scenario where a first STA establishes a first P2P TWT schedule with an associated AP, if the first STA, during the P2P TWT schedule negotiation phase, indicates that the mode of unavailability of the P2P TWT schedule is the probabilistic unavailability mode (Mode-2), and if during the P2P TWT SPs corresponding to the P2P TWT schedule the STA receives an initial control frame from the AP, then upon receiving the ICF, the STA may not send a response frame to indicate that the STA is unavailable for the remainder of the SP.

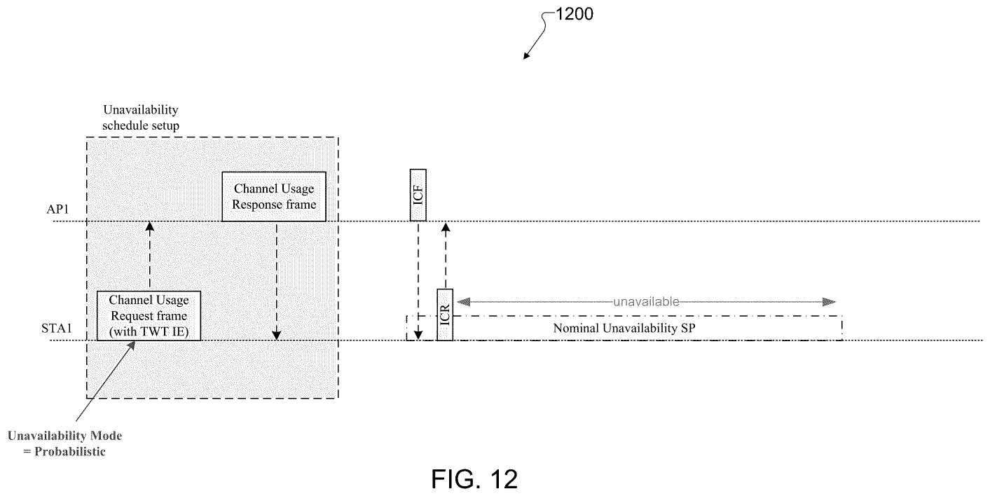

In some embodiments, for the scenario where a first STA establishes a first P2P TWT schedule with an associated AP, if the first STA, during the P2P TWT schedule negotiation phase, indicates that the mode of unavailability of the P2P TWT schedule is the probabilistic unavailability mode (Mode-2), and if during the P2P TWT SPs corresponding to the P2P TWT schedule the STA receives an initial control frame from the AP, then upon receiving the ICF, the STA may send an ICR to the AP, where the ICR is to indicate that the STA is unavailable for the remainder of the SP, as shown in FIG. 12.

FIG. 12 illustrates another example 1200 of AP behavior during a probabilistic unavailability mode according to embodiments of the present disclosure. The embodiment of AP behavior of FIG. 12 is for illustration only. Different embodiments of AP behavior during a probabilistic unavailability mode could be used without departing from the scope of this disclosure.

In the example of FIG. 12, AP1 and STA1 perform an unavailability schedule setup where STA1 transmits a channel usage request frame with a TWT IE to AP1 that includes an indication for a probabilistic unavailability mode, and STA1 receives a channel usage response frame from AP1. After the unavailability schedule setup, AP1 sends an ICF to STA1 at the beginning of the P2P TWT SP and receives an ICR. The ICR indicates that STA1 is not available during the SP, then AP1 does not send any frames to STA1 during the SP or does not solicit any uplink frames during the SP.

Although FIG. 12 illustrates an example 1200 of AP behavior during a probabilistic unavailability mode, various changes may be made to FIG. 12. For example, various changes to unavailability times could be made, etc. according to particular needs.

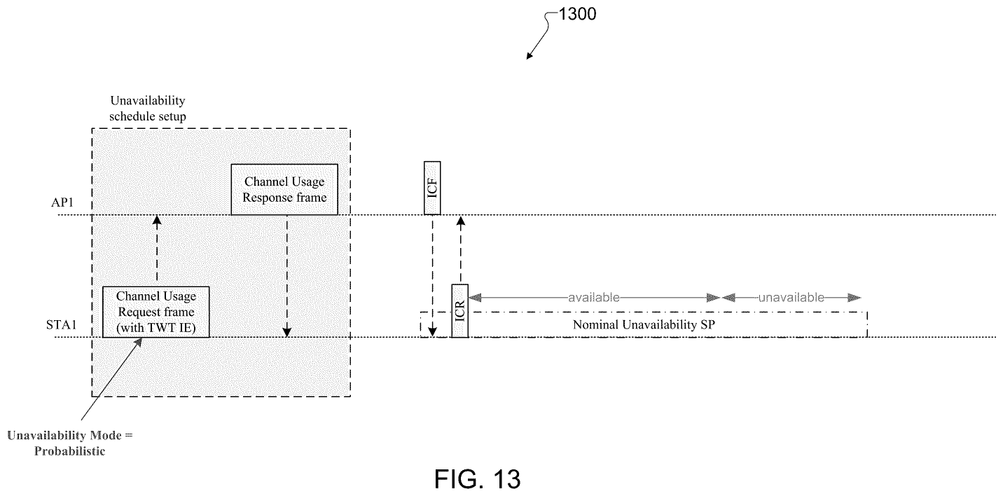

In some embodiments, for the scenario where a first STA establishes a first P2P TWT schedule with an associated AP, if the first STA, during the P2P TWT schedule negotiation phase, indicates that the mode of unavailability of the P2P TWT schedule is the probabilistic unavailability mode (Mode-2), and if during the P2P TWT SPs corresponding to the P2P TWT schedule the STA receives an initial control frame from the AP, then upon receiving the ICF, the STA may send an ICR to the AP, where the ICR can indicate which portion of the SP the STA is available and which portion of the SP the STA may not be available during that SP, as shown in FIG. 13.

FIG. 13 illustrates another example 1300 of AP behavior during a probabilistic unavailability mode according to embodiments of the present disclosure. The embodiment of AP behavior of FIG. 13 is for illustration only. Different embodiments of AP behavior during a probabilistic unavailability mode could be used without departing from the scope of this disclosure.

In the example of FIG. 13, AP1 and STA1 perform an unavailability schedule setup where STA1 transmits a channel usage request frame with a TWT IE to AP1 that includes an indication for a probabilistic unavailability mode, and STA1 receives a channel usage response frame from AP1. After the unavailability schedule setup, AP1 sends an ICF to STA1 at the beginning of the P2P TWT SP, and receives an ICR. The ICR indicates that STA1 is unavailable during a portion of the SP, and unavailable during a different portion of the SP. AP1 can send downlink frames to the STA1 during the SP based on the availability indicated in the response frame.

Although FIG. 13 illustrates an example 1300 of AP behavior during a probabilistic unavailability mode, various changes may be made to FIG. 13. For example, various changes to unavailability times could be made, etc. according to particular needs.

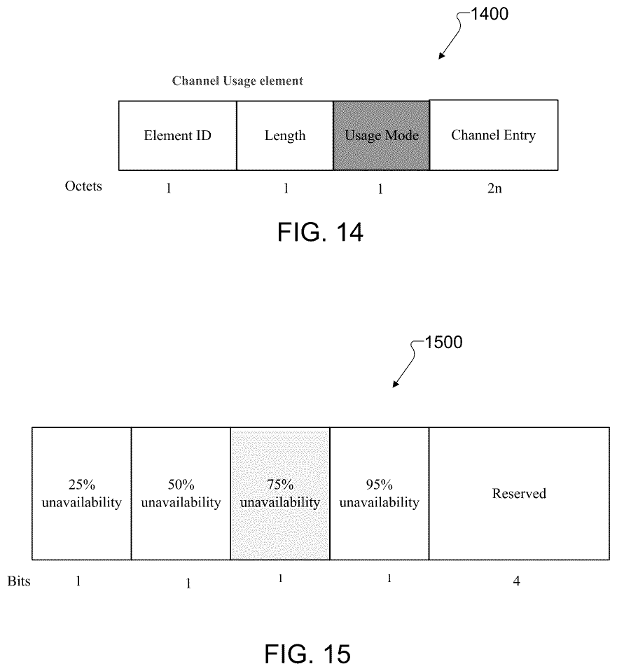

In some embodiments, when a first STA intends to establish a P2P TWT schedule with its associated AP in order to indicate the unavailability schedule of the STA, and sends a channel usage request frame to the AP in order to establish the peer-to-peer TWT schedule with the AP, the first STA can indicate the mode of the P2P TWT SPs in the channel usage elements included in the channel usage request frame. In embodiments such as these, the usage mode field in the channel usage element can include the mode indication. An example of a possible format of the channel usage element, including the usage mode field in the channel usage element is shown in FIG. 14.

FIG. 14 illustrates an example format 1400 of a channel usage element including a usage mode field according to embodiments of the present disclosure. The embodiment of a channel usage element of FIG. 14 is for illustration only. Different embodiments of a channel usage element including a usage mode field could be used without departing from the scope of this disclosure.

In the example of FIG. 14, format 1400 is a channel usage element that includes a usage mode field. The usage mode may be identified by including one of the values shown in table 1 in the usage mode field.

In the example of Table 1, when the value is 3, the usage mode is a complete unavailability indication. In some embodiments, the complete unavailability indication value may indicate that the STA sending the channel usage element intends to establish the P2P TWT for complete unavailability mode.

In the example of Table 1, when the value is 6, the usage mode is a probabilistic unavailability indication. In some embodiments, the probabilistic unavailability indication value may indicate that the STA sending the channel usage element intends to establish the P2P TWT for probabilistic unavailability mode.

TABLE 1
Usage Mode Definitions

| Value | Usage Mode |
|---|---|
| 0 | Channel-usage-aidable BSS |
| 1 | Off-channel TDLS direct link |
| 2 | Channel-usage-aidable BSS in which none of |
| | the channel-usage-aiding BSSs that belong to |
| | the same ESS operate on the channels |
| | identified by the Channel Entry field |
| 3 | Complete Unavailability indication |
| 4 | Channel-usage-aidable BSS channel switch request |
| 5 | Capability notification |
| 6 | Probabilistic Unavailability indication |
| 7-254 | Reserved |
| 255 | Unknown request |

Although FIG. 14 illustrates an example format 1400 of a channel usage element including a usage mode field, various changes may be made to FIG. 14. For example, various changes to fields could be made, etc. according to particular needs.

In some embodiments, when the AP receives a channel usage request frame an associated STA, where the channel usage request frame is for establishing a P2P TWT schedule, and a mode of P2P TWT is indicated in the channel usage element, the AP can send a response frame to the STA where the response frame may also indicate a mode that the AP suggests for the P2P TWT. In embodiments such as these, the P2P TWT mode sent by the AP can be the same or different than the mode indicated by the STA in the request frame.

In some embodiments, when a first STA sends a channel usage request frame to a second STA in order to establish a P2P TWT, where the mode of the P2P TWT is probabilistic unavailability, then an unavailability probability field can be included in the channel usage request frame. The unavailability probability field may indicate a bitmap where each bit of the field may indicate the probability of unavailability of the STA during the P2P TWT SP. An example of a possible format of an unavailability probability field is shown in FIG. 15.

FIG. 15 illustrates an example format 1500 of an unavailability probability field according to embodiments of the present disclosure. The embodiment of an unavailability probability field of FIG. 15 is for illustration only. Different embodiments of an unavailability probability field could be used without departing from the scope of this disclosure.

In the example of FIG. 15, the unavailability probability field is a bitmap. In some embodiments, if the bit corresponding to 25% unavailability is set to 1, then this may indicate that the STA's expected unavailability probability during a P2P TWT SP is higher than 25%. Otherwise, the probability is lower than 25%. In some other embodiments, if the 25% unavailability bit is set to 1, then this may indicate that the STA's expected availability probability during a P2P TWT SP is higher than 25%. Otherwise, the probability is lower than 25%.

Similarly, in some embodiments, if the bit corresponding to 50% unavailability is set to 1, then this may indicate that the STA's expected unavailability probability during a P2P TWT SP is higher than 50%. Otherwise, the probability is lower than 50%. In some other embodiments, if the 50% unavailability is set to 1, then this may indicate that the STA's expected availability probability during a P2P TWT SP is higher than 50%. Otherwise, the probability is lower than 50%. Format 1500 may operate similarly for the other values-75% and 95%.

Although FIG. 15 illustrates an example format 1500 of an unavailability probability field, various changes may be made to FIG. 15. For example, various changes to the bitmap could be made, etc. according to particular needs.

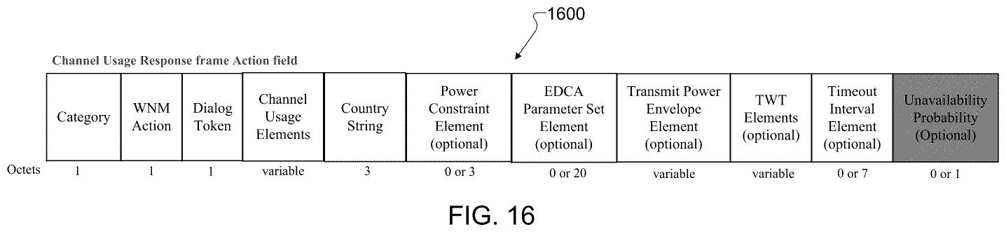

An example of a possible format of a channel usage response frame containing an unavailability probability field is shown in FIG. 16.

FIG. 16 illustrates an example format 1600 of a channel usage response frame containing an unavailability probability field according to embodiments of the present disclosure. The embodiment of a channel usage response frame of FIG. 16 is for illustration only. Different embodiments of a channel usage response frame containing an unavailability probability field could be used without departing from the scope of this disclosure.

In the example of FIG. 16, format 1600 is a channel usage response frame. For format 1600, the unavailability probability field indicates an unavailability probability of the STA transmitting the field. For example, the unavailability probability field may be formatted as shown in FIG. 15.

Although FIG. 16 illustrates an example format 1600 of a channel usage response frame containing an unavailability probability field, various changes may be made to FIG. 16. For example, various changes to the frame could be made, etc. according to particular needs.

In some embodiments, when the AP receives a channel usage request frame from an associated STA, where the channel usage request frame is for establishing a P2P TWT schedule, and a probabilistic unavailability mode of P2P TWT is indicated in the channel usage element of the request frame and a Unavailability Probability field is also included in the channel usage element, the AP can send a response frame to the STA where the response frame may also indicate a probabilistic unavailability mode of P2P TWT and can also include an unavailability probability field in the channel usage element in the channel usage response frame.

In some embodiments, for the scenario where a non-AP STA intends to establish a P2P TWT schedule with its associated AP in order to indicate the non-AP STA's unavailability schedule, if the non-AP STA negotiates with the AP to set up the P2P TWT schedule with the AP, then during the P2P TWT negotiation, the non-AP STA can indicate to the AP a mode of P2P TWT operation where the non-AP STA can receive high-priority traffic from the AP during a P2P TWT SP corresponding to the P2P TWT schedule. As described herein, such a mode may be referred to as a quality of service (QoS)-aware unavailability indication mode.

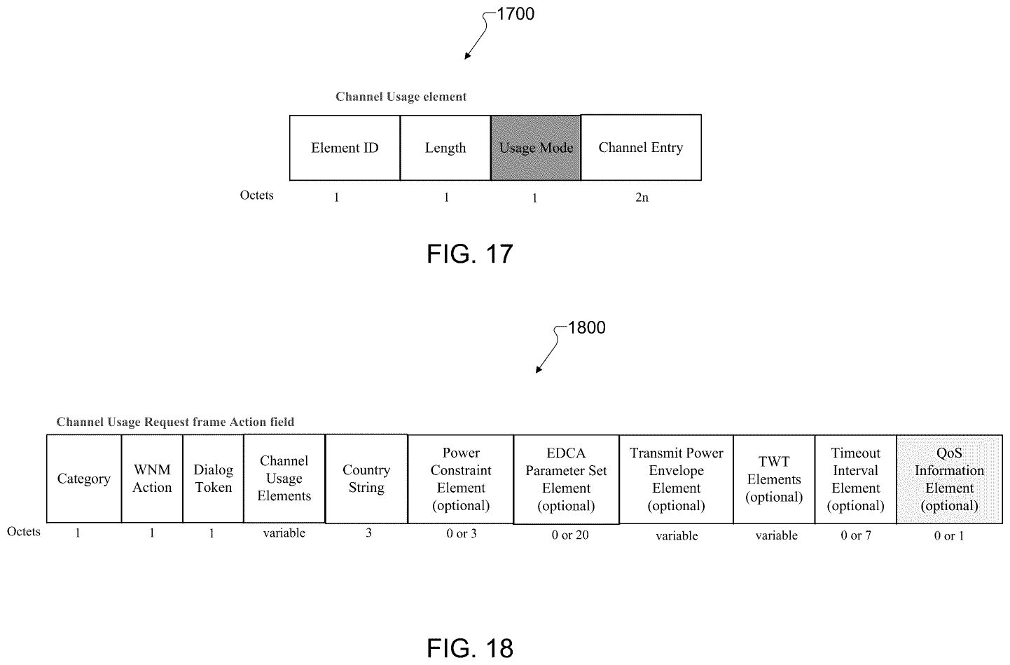

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode is a QoS-aware unavailability mode, then during the P2P TWT negotiation, the non-AP STA can indicate the mode in the usage mode field of the channel usage element included in the channel usage request frame sent by the non-AP STA. An example of a possible format of a channel usage element, including the QoS-aware unavailability indication option, is shown in FIG. 17.

FIG. 17 illustrates an example format 1700 of a QoS-aware unavailability indication option as a mode of P2P TWT unavailability according to embodiments of the present disclosure. The embodiment of a QoS-aware unavailability indication option of FIG. 17 is for illustration only. Different embodiments of a QoS-aware unavailability indication option as a mode of P2P TWT unavailability could be used without departing from the scope of this disclosure.

In the example of FIG. 17, format 1700 is a channel usage element that includes a usage mode field. The usage mode may be identified by including one of the values shown in table 2 in the usage mode field.

In the example of Table 2, when the value is 3, the usage mode is a complete unavailability indication. When the value is 6, the usage mode is a probabilistic unavailability indication. When the value is 7, the usage mode is a QoS aware-unavailability indication.

TABLE 2
Usage Mode Definitions

| Value | Usage Mode |
|---|---|
| 0 | Channel-usage-aidable BSS |
| 1 | Off-channel TDLS direct link |
| 2 | Channel-usage-aidable BSS in which none |
| | of the channel-usage-aiding BSSs that belong |
| | to the same ESS operate on the channels |
| | identified by the Channel Entry field |
| 3 | Complete Unavailability indication |
| 4 | Channel-usage-aidable BSS channel switch request |
| 5 | Capability notification |
| 6 | Probabilistic Unavailability indication |
| 7 | QoS-aware Unavailability indication |
| 8-254 | Reserved |
| 255 | Unknown request |

Although FIG. 17 illustrates an example format 1700 of a QoS-aware unavailability indication option as a mode of P2P TWT unavailability, various changes may be made to FIG. 17. For example, various changes to fields could be made, etc. according to particular needs.

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, the non-AP STA can include a QoS information elements field in the channel usage request frame sent to the AP used for the P2P TWT negotiation. The QoS information element may contain information pertaining to the QoS-related criteria for the availability of the STA during a P2P TWT SP corresponding to the P2P TWT schedule. An example of a possible format of a channel usage request frame including a QoS information element field is shown in FIG. 18.

FIG. 18 illustrates an example format 1800 of a channel usage request frame including a QoS information element field according to embodiments of the present disclosure. The embodiment of a channel usage request frame of FIG. 16 is for illustration only. Different embodiments of a channel usage request frame including a QoS Information Element field could be used without departing from the scope of this disclosure.

In the example of FIG. 18, format 1800 is a channel usage request frame. For format 1800, the QoS information elements field, if included, may contain one or more QoS information elements as described herein.

Although FIG. 18 illustrates an example format 1800 of a channel usage request frame including a QoS information element field, various changes may be made to FIG. 18. For example, various changes to the frame could be made, etc. according to particular needs.

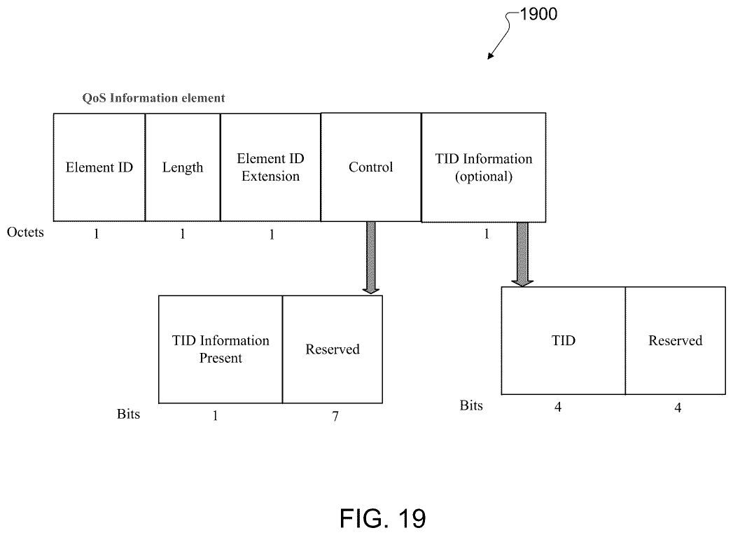

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if non-AP STA includes a QoS information elements field in the channel usage request frame sent to the AP used for the P2P TWT negotiation, then the QoS information element included in the QoS information elements field may include traffic identifier (TID) information. According to one embodiment, if TID information is included, then this may indicate to the AP that the STA may be awake and available during a P2P TWT SP corresponding to the P2P TWT schedule for a downlink frame transmission where the frame belongs to a TID indicated in the element. An example of a possible format of a QoS information element that contains a single TID value is shown in FIG. 19.

FIG. 19 illustrates example format 1900 of a QoS information element that includes a single TID value according to embodiments of the present disclosure. The embodiment of a QoS information element of FIG. 19 is for illustration only. Different embodiments of a QoS information element that includes a single TID value could be used without departing from the scope of this disclosure.

In the example of FIG. 19, whether the TID information is present in the QoS information element is indicated by the TID information present field in the control field. If the TID information present field is set to 1, then this may indicate that the TID information field is present in the QoS information element. Otherwise, it is not present. The TID field in the TID information field indicates a TID value.

Although FIG. 19 illustrates an example format 1900 of a QoS information element that includes a single TID value, various changes may be made to FIG. 19. For example, various changes to fields could be made, etc. according to particular needs.

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if non-AP STA includes a TID value in a QoS information element included in the channel usage request frame sent to the AP used for the P2P TWT negotiation, then this may indicate that the non-AP STA may be available for receiving a frame corresponding to the indicated TID even if the frame reception overlaps with a P2P TWT SP corresponding to the P2P TWT schedule. In some other embodiments, inclusion of the TID may indicate that the non-AP STA may be available for receiving the frame if the frame corresponds to any TID with a value which is greater than the value indicated in the QoS information element.

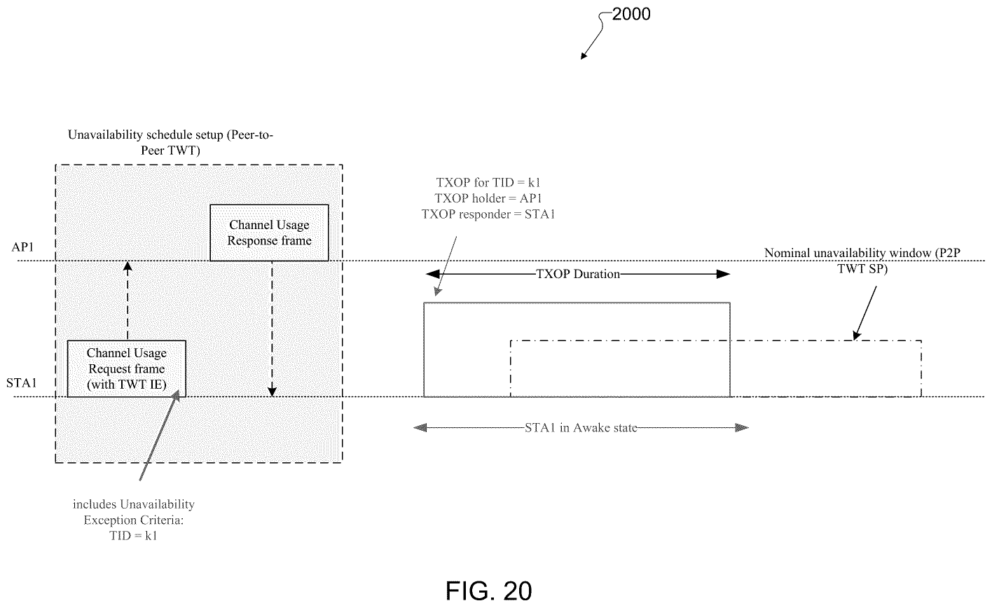

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes a TID value in a QoS information element included in the channel usage request frame sent to the AP used for the P2P TWT negotiation, then this may indicate that the non-AP STA as a transmission opportunity (TXOP) responder may be available (e.g., in awake state) for receiving a frame corresponding to the indicated TID even if the frame reception overlaps with a P2P TWT SP corresponding to the P2P TWT schedule if the frame corresponds to a TID value indicated in the QoS information element included in the channel usage request frame, such as shown in FIG. 20.

FIG. 20 illustrates an example 2000 of STA availability for receiving a frame corresponding to a TID value in a QoS information element according to embodiments of the present disclosure. The embodiment of STA availability for receiving a frame corresponding to a TID value in a QoS information element of FIG. 20 is for illustration only. Different embodiments of STA availability for receiving a frame corresponding to a TID in a QoS information element could be used without departing from the scope of this disclosure.

In the example of FIG. 20, AP1 and STA1 perform an unavailability schedule setup for P2P TWT, where STA1 transmits a channel usage request frame with a TID value in a QoS information element to AP1, and STA1 receives a channel usage response frame from AP1. The channel usage request frame may indicate that STA1 as a TXOP responder may be available for receiving a frame corresponding to the TID even if the frame reception overlaps with a P2P TWT SP corresponding to the P2P TWT schedule if the frame corresponds to the TID value indicated in the QoS information element.

Although FIG. 20 illustrates an example 2000 of STA availability for receiving a frame corresponding to a TID in a QoS information element, various changes may be made to FIG. 20. For example, various changes to unavailability times could be made, etc. according to particular needs.

In some embodiments, if the non-AP STA includes a TID value in a QoS Information element included in the channel usage request frame sent to the AP used for the P2P TWT negotiation, then this may indicate that the non-AP STA as a TXOP responder may not be available for receiving a frame that does not correspond to the TID indicated in the QoS Information element if the frame reception overlaps with a P2P TWT SP corresponding to the P2P TWT schedule. In such cases, the AP as the TXOP holder may end the TXOP before the unavailability SP starts for the non-AP STA.

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes a TID value in a QoS information element included in the channel usage request frame sent to the AP used for the P2P TWT negotiation, then this may indicate that the non-AP STA as a TXOP responder may be available (e.g., in awake state) for receiving a frame corresponding to the indicated TID even if the frame reception overlaps with a P2P TWT SP corresponding to the P2P TWT schedule if the frame corresponds to a TID value which is higher than the value indicated in the TID subfield indicated in the QoS information element included in the channel usage request frame.

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes a TID value in a QoS information element included in the channel usage request frame sent to the AP used for the P2P TWT negotiation, then this may indicate that the non-AP STA as a TXOP responder may be available (e.g., in awake state) for receiving a frame corresponding to the indicated TID even if the frame reception overlaps with a P2P TWT SP corresponding to the P2P TWT schedule if the frame corresponds to a TID value which is lower than the value indicated in the TID subfield indicated in the QoS information element included in the channel usage request frame.

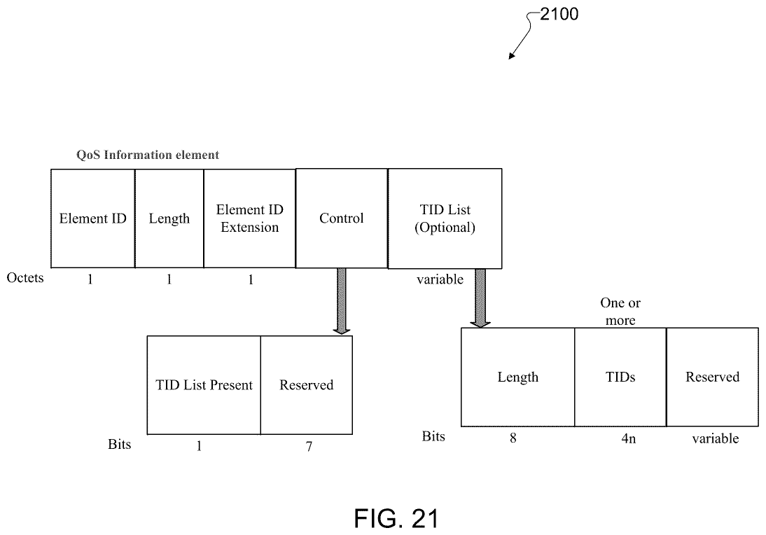

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, then the non-AP STA may indicate multiple TIDs in a QoS information element included in the channel usage request frame sent to the AP used for the P2P TWT negotiation. An example of a possible format of a QoS information element with multiple TIDs is shown in FIG. 21.

FIG. 21 illustrates example format 2100 of a QoS information element that includes multiple TID values according to embodiments of the present disclosure. The embodiment of a QoS information element of FIG. 21 is for illustration only. Different embodiments of a QoS information element that includes multiple TID values could be used without departing from the scope of this disclosure.

In the example of FIG. 21, the QoS information element the TID list subfield may include one or more TID subfields. Each TID subfield may include one or more TID values. The Length field may indicate the length of the TID List subfield.

Although FIG. 21 illustrates an example format 2100 of a QoS information element that includes multiple TID values, various changes may be made to FIG. 21. For example, various changes to fields could be made, etc. according to particular needs.

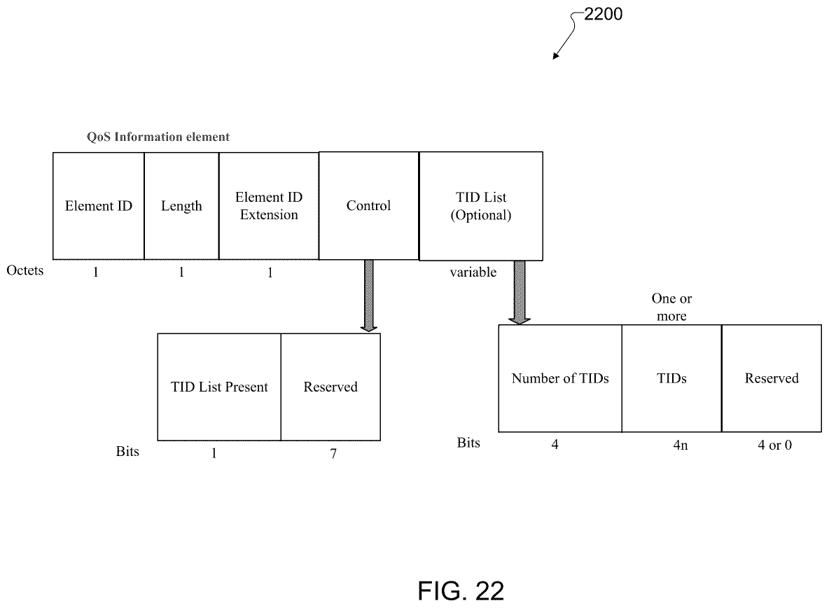

An example of another possible format of a QoS information element with multiple TIDs is shown in FIG. 22.

FIG. 22 illustrates another example format 2200 of a QoS information element that includes multiple TID values according to embodiments of the present disclosure. The embodiment of a QoS information element of FIG. 22 is for illustration only. Different embodiments of a QoS information element that includes multiple TID values could be used without departing from the scope of this disclosure.

In the example of FIG. 22, the TID list subfield in the QoS information element may include one or more TID subfields. Each TIDs subfield may include one or more TID values. The Number of TIDs subfield may indicate the number of TID values included in the TID List subfield of the QoS Information element.

Although FIG. 22 illustrates an example format 2200 of a QoS information element that includes a multiple TID values, various changes may be made to FIG. 22. For example, various changes to fields could be made, etc. according to particular needs.

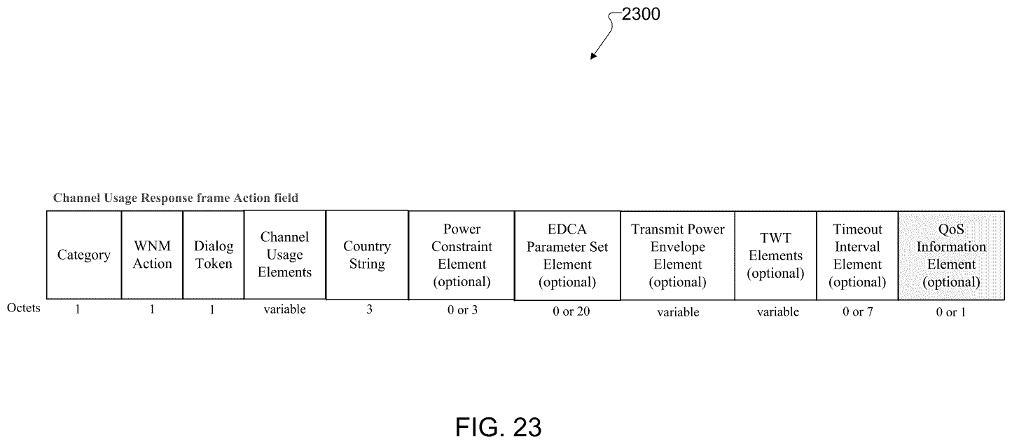

Upon receiving a channel usage request frame from a non-AP STA that includes one or more QoS information elements, the AP may send a channel usage response frame to the non-AP STA, where the channel usage response frame may include one or more QoS information elements. An example of a possible format of a channel usage response frame is shown FIG. 23.

FIG. 23 illustrates an example format 2300 of a channel usage response frame including a QoS information element according to embodiments of the present disclosure. The embodiment of a channel usage response frame of FIG. 23 is for illustration only. Different embodiments of a channel usage response frame including a QoS information element could be used without departing from the scope of this disclosure.

In the example of FIG. 23, format 2300 is a channel usage response frame. For format 2300, the QoS information element may be formatted as described herein.

Although FIG. 23 illustrates an example format 2300 of a channel usage response frame including a QoS information element, various changes may be made to FIG. 23. For example, various changes to the frame could be made, etc. according to particular needs.

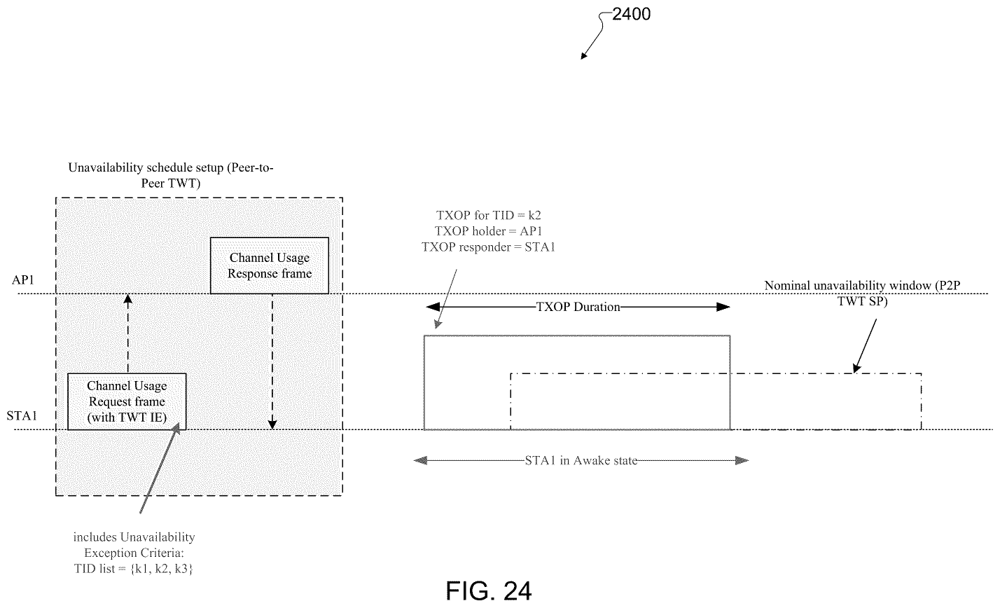

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes one or more TID values (a list of TIDs) in a QoS Information element included in the channel usage request frame sent to the AP used for the P2P TWT negotiation, then this may indicate that the non-AP STA as a TXOP responder may be available (e.g., in awake state) for receiving a frame corresponding to a TID that is indicated in the list of TIDs even if the frame reception overlaps with a P2P TWT SP corresponding to the P2P TWT schedule if the frame correspond to a TID value indicated in the QoS Information element included in the channel usage request frame, as shown in FIG. 24.

FIG. 24 illustrates an example 2400 of STA availability for receiving a frame corresponding to a TID listed in a QoS information element according to embodiments of the present disclosure. The embodiment of STA availability for receiving a frame corresponding to a TID listed in a QoS information element of FIG. 24 is for illustration only. Different embodiments of STA availability for receiving a frame corresponding to TID listed in a QoS information element could be used without departing from the scope of this disclosure.

In the example of FIG. 24, AP1 and STA1 perform an unavailability schedule setup for P2P TWT, where STA1 transmits a channel usage request frame with one or more TID values (a list of TIDs) in a QoS information element to AP1, and STA1 receives a channel usage response frame from AP1. The channel usage request frame may indicate that STA1 as a TXOP responder may be available for receiving a frame corresponding to a TID that is indicated in the list of TIDs even if the frame reception overlaps with a P2P TWT SP corresponding to the P2P TWT schedule if the frame corresponds to an TID value indicated in the QoS information element.

Although FIG. 24 illustrates an example 2400 of STA availability for receiving a frame corresponding to TID listed in a QoS information element, various changes may be made to FIG. 24. For example, various changes to unavailability times could be made, etc. according to particular needs.

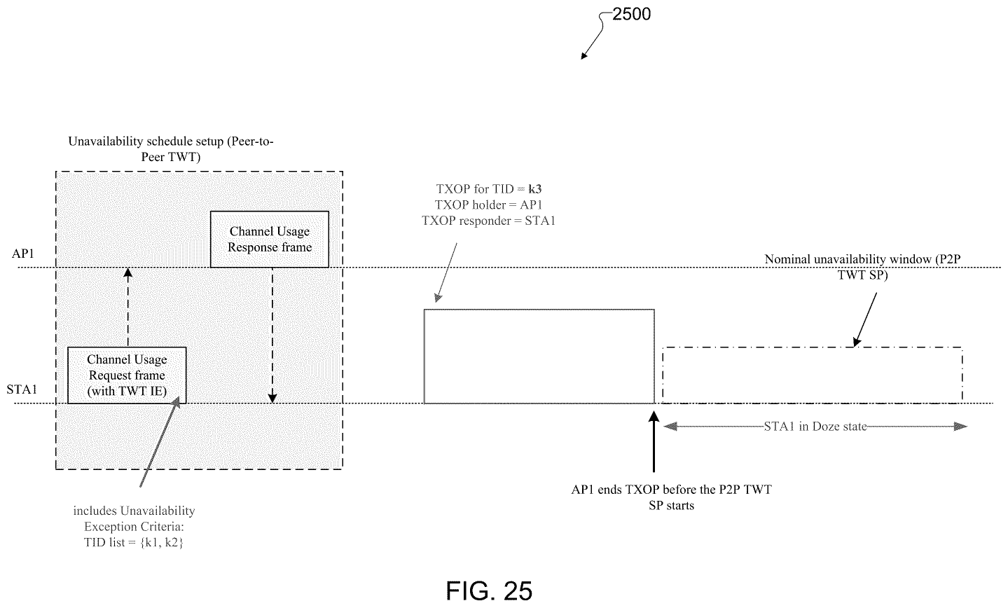

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes one or more TID values (a list of TIDs) in a QoS Information element included in the channel usage request frame sent to the AP used for the P2P TWT negotiation, then this may indicate that the non-AP STA as a TXOP responder may not be available (e.g., may be in doze state) for receiving a frame corresponding to a TID that is not included in the TID List if the frame reception overlaps with a P2P TWT SP corresponding to the P2P TWT schedule, as shown in FIG. 25.

FIG. 25 illustrates another example 2500 of STA availability for receiving a frame corresponding to a TID listed in a QoS information element according to embodiments of the present disclosure. The embodiment of STA availability for receiving a frame corresponding to a TID listed in a QoS information element of FIG. 25 is for illustration only. Different embodiments of STA availability for receiving a frame corresponding to a TID listed in a QoS information element could be used without departing from the scope of this disclosure.

In the example of FIG. 25, AP1 and STA1 perform an unavailability schedule setup for P2P TWT, where STA1 transmits a channel usage request frame with an one or more TID values (a list of TIDs) in a QoS information element to AP1, and STA1 receives a channel usage response frame from AP1. The channel usage request frame may indicate that STA1 as a TXOP responder may not be available for receiving a frame corresponding to a TID that is not included in the list of TIDs if the frame reception overlaps with a P2P TWT SP corresponding to the P2P TWT schedule.

Although FIG. 25 illustrates an example 2500 of STA availability for receiving a frame corresponding to a TID listed in a QoS information element, various changes may be made to FIG. 25. For example, various changes to unavailability times could be made, etc. according to particular needs.

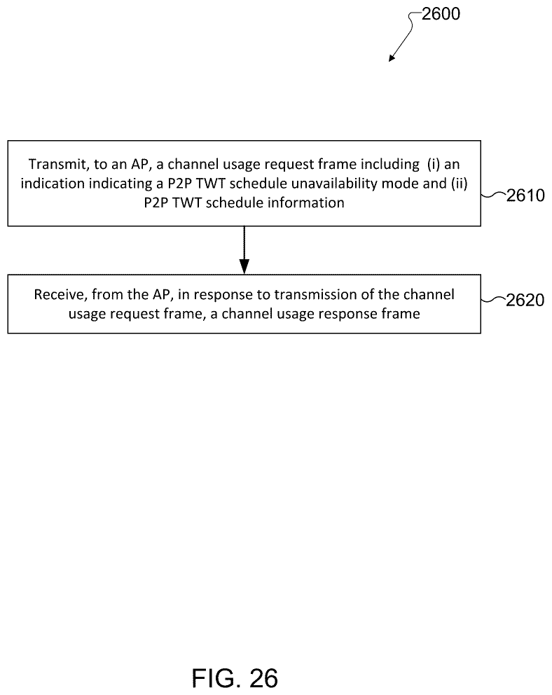

FIG. 26 illustrates an example method 2600 for enhanced P2P TWT operation according to embodiments of the present disclosure. An embodiment of the method illustrated in FIG. 26 is for illustration only. One or more of the components illustrated in FIG. 26 may be implemented in specialized circuitry configured to perform the noted functions or one or more of the components may be implemented by one or more processors executing instructions to perform the noted functions. Other embodiments of a method for enhanced P2P TWT operation could be used without departing from the scope of this disclosure.

In the example of FIG. 26, method 2600 begins at step 2610. A step 2610 a STA (such as STA1 of FIG. 10) transmits, to an AP (such as AP1 of FIG. 10), a channel usage request frame including (i) an indication indicating a P2P TWT schedule unavailability mode and (ii) P2P TWT schedule information.

In some embodiments, the indication may be included in a usage mode field of a channel usage element of the channel usage request frame.

In some embodiments, the unavailability mode may be a complete unavailability mode, and the P2P TWT schedule information may indicate that the STA may not be available for communication with the AP during any SPs corresponding to the P2P TWT schedule. In these embodiments, the AP may assume that the STA is completely unavailable during all SPs corresponding with the P2P TWT schedule, and may not attempt to deliver any downlink packets or BUs to the STA during any of the SPs corresponding with the P2P TWT schedule.

In some embodiments, the unavailability mode may be a probabilistic unavailability mode, and the P2P TWT schedule information may indicate that (i) the STA may not be available for communication with the AP during a first subset SPs corresponding to the P2P TWT schedule and (ii) may be available for communication with the AP during a second subset of SPs corresponding to the P2P TWT schedule.

In some embodiments, the unavailability mode may be a QoS aware unavailability mode, and the channel usage request frame may include a QoS information elements field. In these embodiments, the QoS information elements field may include a TID information value.

In some embodiments, the TID information indicates an SP corresponding with the P2P TWT schedule where the STA is available for a downlink frame transmission corresponding with a TID indicated by TID information value.

In some embodiments the TID information value indicates an SP corresponding with the P2P TWT schedule where the STA is available for a downlink frame transmission corresponding with a TID greater than the TID information value.

In some embodiments the TID information value indicates an SP corresponding with the P2P TWT schedule where the STA is available for a downlink frame transmission corresponding with a TID less than the TID information value.

At step 2620, the STA receives, from the AP, in response to transmission of the channel usage request frame, a channel usage response frame.

In some embodiments, the STA may receive an ICF from the AP at a beginning of an SP corresponding to the P2P TWT schedule. In these embodiments, the STA may determine whether the STA is available during the SP, and transmit an ICR based on the determination.

Although FIG. 26 illustrates one example method 2600 for enhanced P2P TWT operation, various changes may be made to FIG. 26. For example, while shown as a series of steps, various steps in FIG. 26 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A station (STA) comprising:
a processor; and
a transceiver operatively coupled to the processor, the transceiver configured to, as part of a peer-to-peer (P2P) target wake time (TWT) negotiation:
transmit, to an access point (AP), a channel usage request frame including (i) an indication indicating a P2P TWT schedule unavailability mode and (ii) P2P TWT schedule information; and
receive, from the AP, in response to transmission of the channel usage request frame, a channel usage response frame.

2. The STA of claim 1, wherein the indication is included in a usage mode field of a channel usage element of the channel usage request frame.

3. The STA of claim 1, wherein:
the unavailability mode is a complete unavailability mode, and
the P2P TWT schedule information indicates that the STA may not be available for communication with the AP during any service periods (SPs) corresponding to the P2P TWT schedule.

4. The STA of claim 3, wherein:
the AP assumes that the STA is completely unavailable during all SPs corresponding with the P2P TWT schedule, and
the AP does not attempt to deliver any downlink packets or buffered units (BUs) to the STA during any of the SPs corresponding with the P2P TWT schedule.

5. The STA of claim 1, wherein:
the unavailability mode is a probabilistic unavailability mode, and
the P2P TWT schedule information indicates that (i) the STA may not be available for communication with the AP during a first subset of service periods (SPs) corresponding to the P2P TWT schedule and (ii) may be available for communication with the AP during a second subset of SPs corresponding to the P2P TWT schedule.

6. The STA of claim 5, wherein:
the transceiver is further configured to receive an initial control frame (ICF) from the AP at a beginning of an SP corresponding to the P2P TWT schedule; and
the processor is further configured to, in response to receipt of the ICF:
determine whether the STA is available during the SP; and
cause the transceiver to transmit an initial control response frame (ICR) based on the determination.

7. The STA of claim 1, wherein:
the unavailability mode is a quality of service (QoS) aware unavailability mode; and
the channel usage request frame includes a QoS information elements field, the QoS information elements field including a traffic identifier (TID) information value.

8. The STA of claim 7, wherein the TID information value indicates a service period (SP) corresponding with the P2P TWT schedule where the STA is available for a downlink frame transmission corresponding with a TID indicated by TID information value.

9. The STA of claim 7, wherein the TID information value indicates a service period (SP) corresponding with the P2P TWT schedule where the STA is available for a downlink frame transmission corresponding with a TID greater than the TID information value.

10. The STA of claim 7, wherein the TID information value indicates a service period (SP) corresponding with the P2P TWT schedule where the STA is available for a downlink frame transmission corresponding with a TID less than the TID information value.

11. An access point (AP) comprising:
a processor; and
a transceiver operatively coupled to the processor, the transceiver configured to, as part of a peer-to-peer (PTP) target wake time (TWT) negotiation:
receive, from a station (STA), a channel usage request frame including (i) an indication indicating a P2P TWT schedule unavailability mode and (ii) P2P TWT schedule information; and
transmit, to the STA, in response to receipt of the channel usage request frame, a channel usage response frame.

12. The AP of claim 11, wherein the indication is included in a usage mode field of a channel usage element of the channel usage request frame.

13. The AP of claim 11, wherein:
the unavailability mode is a complete unavailability mode, and
the P2P TWT schedule information indicates that the STA may not be available for communication with the AP during any service periods (SPs) corresponding to the P2P TWT schedule.

14. The AP of claim 13, wherein:
the AP assumes that the STA is completely unavailable during all SPs corresponding with the P2P TWT schedule, and
the AP does not attempt to deliver any downlink packets or buffered units (BUs) to the STA during any of the SPs corresponding with the P2P TWT schedule.

15. The AP of claim 11, wherein:
the unavailability mode is a probabilistic unavailability mode, and
the P2P TWT schedule information indicates that (i) the STA may not be available for communication with the AP during a first subset of service periods (SPs) corresponding to the P2P TWT schedule and (ii) may be available for communication with the AP during a second subset of SPs corresponding to the P2P TWT schedule.

16. The AP of claim 15, wherein:
the transceiver is further configured to transmit an initial control frame (ICF) to the STA at a beginning of an SP corresponding to the P2P TWT schedule; and
receive an initial control response frame (ICR) from the STA indicating whether the STA is available during the SP.

17. The AP of claim 11, wherein:
the unavailability mode is a quality of service (QoS) aware unavailability mode; and
the channel usage request frame includes a QoS information elements field, the QoS information elements field including a traffic identifier (TID) information value.

18. The AP of claim 17, wherein the TID information value indicates a service period (SP) corresponding with the P2P TWT schedule where the STA is available for a downlink frame transmission corresponding with a TID indicated by the TID information value.

19. The AP of claim 17, wherein the TID information value indicates a service period (SP) corresponding with the P2P TWT schedule where the STA is available for a downlink frame transmission corresponding with a TID greater than the TID information value.

20. The AP of claim 17, wherein the TID information value indicates a service period (SP) corresponding with the P2P TWT schedule where the STA is available for a downlink frame transmission corresponding with a TID less than the TID information value.
